(19) United States
(12) Patent Application Publication
(10) Pub. No.: US 2022/0159908 A1
(43) Pub. Date: May 26, 2022

(54) LASER TRIMMING DEVICE AND METHOD

(71) Applicants: James C. Young, Fargo, ND (US); Maria Angelica Young, Fargo, ND (US)

(72) Inventors: James C. Young, Fargo, ND (US); Maria Angelica Young, Fargo, ND (US)

(21) Appl. No.: 17/531,679

(22) Filed: Nov. 19, 2021

Related U.S. Application Data
(60) Provisional application No. 63/118,270, filed on Nov. 25, 2020.

(51) Int. Cl. A01G 3/047; A01G 3/06

(52) U.S. Cl. CPC A01G 3/047; A01G 3/08; A01G 3/06

(57) ABSTRACT

A cutting apparatus including a plurality of laser beams for cutting vegetation. The apparatus comprises a housing including an electrically powered laser cutting device which is positioned centrally within the housing. The laser cutting device generates at least one laser beam that is directed outwards from the housing wherein the laser is absorbed by a plate attached to a metal guide at the end of the effective cutting length of the laser.

### FIELD OF INVENTION

The invention relates to an apparatus and method for cutting vegetation with a trimmer such as bushes, trees, and other similar plants. More specifically, the invention relates to an apparatus and method for cutting vegetation with focused laser beams in a trimmer.

### DESCRIPTION OF THE RELATED ART

Prior trimmer devices include manually powered cutters, and electric and gasoline powered motors driving rigid, moving cutting blades operated by a series of drive spindles, belts, drive shafts, and gearing devices. Prior cutting blades require periodic sharpening of the blades and periodic replacement due to wear and tear cutting through thick wood and vegetation causes the blades. The power producing motors and cutting blades require speed limitations imposed by industry safety standards on the engine and/or blade rotation mechanisms to limit blade tip speeds as a function of the length of the mower blade as a safety measure for limiting the damages to adjacent objects or the operator when blades impact and shatter against hard objects. Commercial trimming operations would benefit from a cutting apparatus that incorporates a cutting means that does not use metal cutting means so as to minimize the chances of failures and injuries

The gasoline powered motors and rotating cutting blades of traditional trimmers are noisy when operated and are relatively heavy and cumbersome to operate due to the weight of the motors, drive spindles, belts, chains, and rotating cutting blades. Similarly, manual cutting blades such as scissors and saws can also be cumbersome and difficult to use in some situations.

A need exists in the vegetation control industry for a reliable, portable cutting apparatus that can trim vegetation and that includes a minimum of moving parts.

Therefore, it is an object of the present invention to provide a cutting means for trimming vegetation.

It is another object of the present invention to provide an apparatus having a cutting means that is adjustable by a user.

It is another object of the present invention to provide an apparatus having a cutting means that includes a minimum of belts and rotating blades.

It is another object of the present invention to provide an apparatus having a cutting means that does not generate excess noise and minimizes use of moving blades.

### BRIEF SUMMARY OF INVENTION

An apparatus for cutting vegetation, and a method for operating the apparatus, is disclosed with the apparatus being controlled by a user for movement at variable speeds along a plant, bush or other vegetation to be trimmed by a laser cutting means that is adjustable to project laser beams outward from a central unit to an end laser absorbing piece to allow the laser to cut through vegetation.

The herein described apparatus comprises at least one laser generation device and collector lens in the formation, the laser beam of described laser instrument output is radiated at after collector lens converges on the plant to be pruned.

The herein described apparatus of a laser vegetation pruning machine also comprises the speculum that is arranged between laser instrument and the collector lens in the formation, the laser beam of laser instrument output is through shining on the collector lens after the mirror reflects.

Above-mentioned laser vegetation pruning machine may also comprise a blowing drum coaxial with collector lens in the formation, the front end of described blowing drum is punctured into nozzle, and rear end and collector lens are tightly connected.

The apparatus utilizes the laser beam of high-power density to replace garden shears that plant is pruned, when the branches and leaves of plant are arrived in laser beam flying, irradiated position can be heated to several thousand to up to ten thousand degrees centigrade at the utmost point in the short time, branches and leaves are broken, reach the purpose of pruning. Because when the laser is used to prune a plant, it will contact with the plant without any mechanical part, and the plant cannot be pruned or bent out of shape, and helps molding the size and shape of the plant.

In addition, the current apparatus provides a faster trimmer speed because of the efficient speed of the device, manpower, time and energy is save. The effect of speculum is the direction of illumination that changes laser, makes the layout of laser instrument more flexible. The blowing drum not only can be protected by the collector lens, the branches and leaves that break can also be blown away and give the position of pruning cooling. When compared with traditional garden shears, the apparatus is easy to operate, quick, can reduce prune picker's labor intensity greatly, improves prune picker's operating efficiency, and prunes the quality height, obtains desirable pruning effect easily.

Accordingly, the present invention is made in an effort to resolve the above-mentioned problems. It is an object of the present invention to provide an agricultural robot system which makes it possible to cut peduncles or thin blossoms more quickly and sanitarily in such a way to cut peduncles or burn blossoms by radiating a laser beam through the apparatus.

To achieve the above-object, there is provided a laser beam generator provided to generate a laser beam; radiating the laser beam from the laser beam generator; collecting the laser beam on an end plate that is an adjustable distance from the housing unit.

The present invention provides a trimmer system which allows the apparatus to cut peduncles and thin blossoms in such a way to radiate a laser beam in a non-contact fashion using a Galvano-scanner, thus preventing any damages to plants and infection of bacteria while obtaining quick work and saving on labor.

Preferably, the length and cutting position of the lasers during the cutting may differ depending on the kinds thereof and working environment. For example, if there are any worries about damages to the fruits due to the collisions between the fruits, the length of the laser may be made very short so as to prevent any poking or the length thereof may be made as long as possible, thus preventing any damage to other fruits by letting the peduncle bend even when colliding with the other fruits.

### BRIEF DESCRIPTION OF THE DRAWINGS

FIG. 1 is a picture of the housing unit, lasers, guide and laser absorbing plate.

FIG. 2 shows the interlocks necessary to safely operate the apparatus in one embodiment.

### DETAILED DESCRIPTION

In accordance with the present invention, there are provided both an apparatus for improved cutting of vegetation, and a method for operating the apparatus. The cutting apparatus is movable by a user at various speeds along vegetation for cutting the vegetation with a laser cutting means that is adjustable to project focused laser beams outwards for cutting and trimming vegetation. The method is using the laser generating device as trimmer to remove vegetation in a desired geometric pattern.

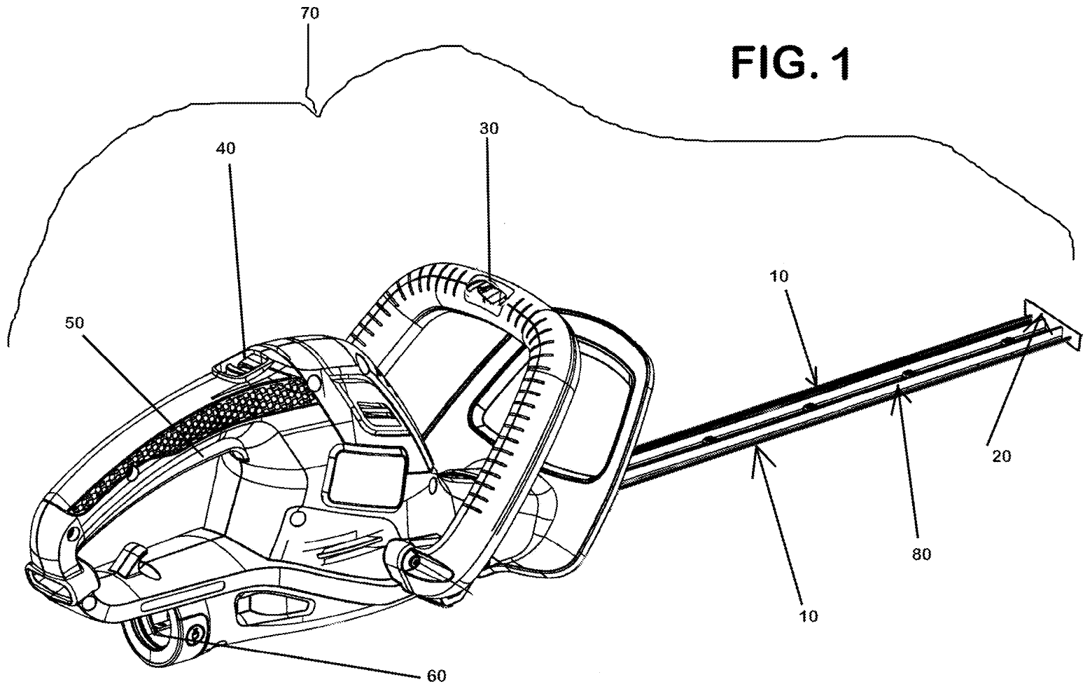

As seen in FIG. 1, the improved cutting apparatus includes a housing, 70, having a laser generation device (not shown and interior to the housing unit), guide lines, 80, attached to the housing unit, 70, control systems to control the laser beam, 10, and an end piece, 20, attached to the guide lines, 80, to absorb the laser beams, 10. Further, the device has a port, 60, wherein an electrical cord can be plugged into the device to allow it to be powered by an external power source.

The currently disclosed device is similar to the popular hedge trimmers in use today. The only difference instead of using metal blades that get dull, broken, or rust the current apparatus is using lasers. The laser will be more effective in cutting through tree branches and bushes and is better than its metal blade counterpart. The Laser Hedge Cutter does not need any replacement blades and will run off electricity or battery.

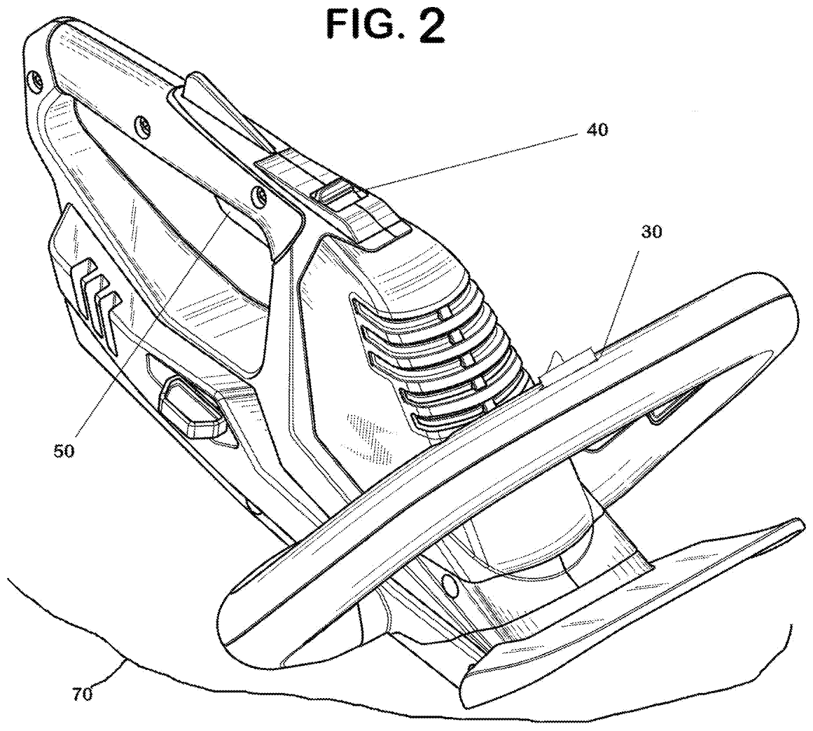

A control system is installed on the housing unit. In general, there will be a plurality of control switches. As seen in FIG. 1 and FIG. 2, in one embodiment there will be three (3) safety switches, 30, 40, and 50, to that must be activated to turn on the device. This will force the user to user both hands when using this device. The main handle will have a thumb switch, 50, and a trigger, 40. And the other 3^{rd} switch, 30, will be where the other hand will have to activate it.

The concern that a user will injure themselves with the device will be high, but if the user must use both hands to operate the device, then this risk is minimized. Further the device will have a metal rod, or guide wires, with lasers on both sides of the metal or guide wires that will cut anything that breaks the beam. The device can be used with both right or left-handed people.

As previously mentioned in one embodiment there are three triggers. The first rigger must be pulled and is the first of three that must be activated to start the device. The second trigger will be located at the top of the handle which must be pushed forward to active the device. The third trigger will be a button and will force the user to use the other hand to activate and be able to turn the device on. This will make sure both hands are not in the area of the lasers which will cause injury.

The device will use a high energy laser cutting beam. These beams will be on both sides of a metal rod or guide wire which will be used to cut bushes or tree branches.

In the current embodiment, there are multiple switches and interlocks on the hand guard, and on the opposite side of the handle there is a switch lock, while the power cables for the switch and the lock are inside the handle to ensure safety.

The laser system located in the head of the apparatus consists of a collimator, a filter and a focusing lens. The optical system makes it possible to obtain the output beam with the assumed wavelength and to focus it appropriately.

Preferably, the band of the fiber laser is in the range from that is standard for lasers used to cut, trim, or otherwise impact vegetation.

Preferably, the semiconductor laser pump system has an output power that is standard for lasers used to cut, trim, or otherwise impact vegetation.

Cutting with a laser pruner according to the invention, which uses a laser, is an alternative to cutting with secateurs equipped with mechanical blades with a hydraulic or pneumatic drive. The geometry of the laser beam does not threaten the environment, and at the same time has a surface power density sufficient to cut wood. The maximum cutting thickness of the secateurs can be adjusted as desired by the user.

When cutting wood, a slight charring of the cut wood surface occurs and the wound cells are closed. This phenomenon protects the tree against the ingress of bacterial and fungal pathogens. Thanks to this, there is no need to spray the orchard after cutting the orchard to protect it against diseases caused by pathogens penetrating through the wounds formed during cutting. This is an additional advantage of the pruning shears according to the invention, as it allows to reduce the amount of chemicals used in orchard production.

The laser according to the invention can be supplied from a current generator with a power depending on the power of the laser used. Alternatively, the power supply can come from an direct source such as a power cord, extension cord, portable generators, or other similar system or method.

A control means is positioned proximate to the housing with the laser cutting means being controlled by the control means for the strength, number of laser beams, and intensity of the laser beams. Electrical power is provided to the laser cutting means by a power means being detachably connected to the housing, an extension cord, or with the power means preferably being a rechargeable battery and/or a gasoline powered electrical generator.

The control means includes an electrical interface positioned proximate to the upper surface of the housing, with the electrical interface providing user control of the movement, width, height, strength and intensity of the laser beam generator, providing user control of the intensity of the rotatable laser beam. A plurality of laser beams can be generated simultaneously by the laser beam generator or by separate laser beam generators with user manipulated controls being positioned proximate the position of the user in relation to the transport means.

The laser cutting means of the apparatus operates with reduced noise due to a lack of traditional blades and operates with a reduced number of moving mechanical parts thereby reducing maintenance requirements.

The at least one laser beam is transmitted generally from the end section of laser beam generator along the metal rod or guide wire from the housing unit. Further the apparatus may include a laser adjustment means which includes an adjustment means known to those skilled in the art for adjustments of the intensity, strength, and effective length of the at least one laser beam transmitted in the direction away from the apparatus.

The at least one laser beam is generated by the laser beam generator which is continuously active in strength, intensity, height, width, and energy to act in a means to cut vegetation, while being controlled by the user during vegetation cutting operations. The at least one laser beam can be directed outward from the housing unit to the vegetation. A plurality of light absorbing materials are positioned against the end piece of the apparatus, as seen in FIG. 1.

The at least one laser beam configuration can include alternative embodiments, including a second embodiment having at least two laser beam generators, or a third embodiment having three laser beam generators at a plurality of angles.

The apparatus, as previous mentioned, may have a system control means that is positioned on the apparatus and may either be attached on the surface of the apparatus or attached on user operated control arms. The laser cutting means is controlled by electronic circuitry within, and/or connectable to, the system control means which measures ground speed of the transport mean, the directions of the laser beam(s), and other operating parameters of the laser beam generator. The user is able to override the circuitry to adjust the height, intensity, width, or strength of the at least one laser beam as the cutting apparatus is transported across the vegetation to be cut. The system control means can include a ground speed indicator and electrical circuitry that is known to those skilled in the art to adjust the height, intensity, width, or strength of the laser beams in proportion to changes in the ground speed of the cutting apparatus.

Electrical power can be provided to the laser cutting means by an electrical power means being detachably connected to the housing, with the electrical power means being a plurality of rechargeable batteries, and/or an electrical generator operated by a power generation means. The electrical generator provides electrical power sufficient to operate the laser beam generator. For a plurality of batteries provided, the batteries may be rechargeable batteries known to those skilled in the art.

The control means can include controls having a plurality of electrical and mechanical interfaces positioned proximate to the user operating position for each alternative embodiment. The electrical and mechanical interfaces provide user control of the intensity, energy and effective height of each laser

Electrical circuitry known to those skilled in the art can automatically increase the intensity of the laser beam generator as the ground speed of the transport means increases to increase the cutting strength of the laser beams in proportion to the speed of travel across the surface covered by vegetation.

A number of associated electronic and mechanical components known to those skilled in the art are not illustrated but can be incorporated without interfering with the objects and advantages of the present invention. An electrical generator can be sized appropriately to provide sufficient power to operate a plurality of laser beam generators in separate housings each having a plurality of laser beams projected outwards within each housing

While a preferred embodiment is shown and described, it will be understood that it is not intended to limit the disclosure, but rather it is intended to cover all modification and alternate methods falling within the spirit and the scope of the invention as defined in the appended claims. One skilled in the art will recognize variations and associated alternative embodiments. The foregoing description should not be limited to the description of the embodiment of the invention contained herein.

What is claimed is:

1. An apparatus for cutting vegetation, the apparatus controlled by a user for movement along vegetation, said apparatus comprising:
a housing connected to a laser generating unit, a metal guide with a first and second end, wherein the first end of the metal guide is attached directly to the housing unit, the metal guide extends horizontally from the housing unit, and the second end of the metal guide is attached to a metal plater wherein the metal plate has a laser absorbing material on it, and wherein the laser generating unit produces lasers outward from the housing along the metal guide from the first end to the second end wherein the laser if of sufficient power, energy and strength to cut through vegetation that a user desires to be removed.
